(19) United States
(12) Patent Application Publication
(10) Pub. No.: US 2014/0267234 A1
(43) Pub. Date: Sep. 18, 2014

(54) Generation and Sharing Coordinate System Between Users on Mobile

(71) Applicants: Anselm Hook, San Francisco, CA (US); Pierre Fite-Georgel, San Francisco, CA (US); Matt Meisnieks, San Francisco, CA (US); Anthony Maes, San Francisco, CA (US); Marc Gardeya, San Francisco, CA (US); Leonid Naimark, Boston, MA (US)

(72) Inventors: Anselm Hook, San Francisco, CA (US); Pierre Fite-Georgel, San Francisco, CA (US); Matt Meisnieks, San Francisco, CA (US); Anthony Maes, San Francisco, CA (US); Marc Gardeya, San Francisco, CA (US); Leonid Naimark, Boston, MA (US)

(21) Appl. No.: 13/835,822

(22) Filed: Mar. 15, 2013

(51) Int. Cl. G06T 19/00; G06T 17/05

(52) U.S. Cl. CPC G06T 19/006; G06T 17/05
USPC 345/419; 345/633

(57) ABSTRACT

A multi-device system for mobile devices to acquire and share 3D maps of an environment. The mobile devices determine features of the environment and construct a local map and coordinate system for the features identified by the mobile device. The mobile devices may create a joint map by joining the local map of another mobile device or by merging the local maps created by the mobile devices. To merge maps, the coordinate system of each system may be constrained in degrees of freedom using information from sensors on the devices to determine the global position and orientation of each device. When the devices operate on a joint map, the device share information about new features to extend the range of features on the map and share information about augmented reality objects manipulated by users of each device.

### BACKGROUND

1. Field of Art

The disclosure generally relates to the field of three-dimensional (3D) mapping, and more particularly to collaborative processing of 3D environmental maps.

2. Description of the Related Art

Interactions with the world through augmented reality (AR) systems are used in various systems, such as navigation, guiding, maintenance, architecture and 3D modeling, simulation and training, virtual fitting and gaming. Augmented reality systems enable users to view generated content along with real world content. For example, information about a restaurant may be superimposed on an image of the restaurant's storefront, or a game may use information about an environment to place virtual content on the real world environment.

Thus, the computer computes placement of the virtual objects and typically places the augmented objects in a real setting. For many applications, the computer is a mobile device, which typically means that it is battery operated and generally has reduced computing strength relative to other systems. A tracking system on the mobile device provides a method to identify coordinates of the device in six-degrees-of-freedom (6DOF), with sufficient accuracy that virtual content can be merged (registered) well with the real world.

Augmented Reality systems are generally location based, such as by global location (e.g., displaying restaurant menu information) or by local location (e.g., local terrain on a surface of a table). In both cases a location of the device (user) relative to the real world needs to be known to the processing unit, which is achieved by a tracking system.

Individual augmented reality systems may construct localized views of the environment as a whole and register local coordinate systems for the environment. Thus, individual systems do not interact with one another as the information known by each system is individualized to each set of features and coordinate system.

These systems algorithm do not allow two or more users (or other multi-player variants) to have a collaborative AR experience while sharing whole (or part) of a map between them and allow interaction of virtual reality content among multiple mobile devices.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates one embodiments of an environment for a collaborative multi-user augmented reality experience.

FIG. 2A-B illustrate map creation and handling according to various embodiments.

FIG. 3 is a method for illustrates map processing on a server with a simultaneous broadcast mechanism to participating devices.

FIG. 4A illustrates a method for using maps initialized from a map on a first device.

FIG. 4B illustrates another embodiment wherein each device initially determines local features and a local coordinate system.

FIG. 4C illustrates the close-up of a Broadcast Block, illustrating methods of broadcasting map data.

FIG. 5A illustrates an exchange of data after the devices have merged maps and identified the position of the device relative to the merged map.

FIG. 5B illustrates a similar exchange of virtual assets without a server.

FIG. 6 illustrates one embodiment of components of an example machine able to read instructions from a machine-readable medium and execute them in a processor (or controller).

FIG. 7 illustrates one embodiment of a mobile device 700 implementing a shared coordinate system.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium that includes operation of an augmented reality device that coordinates a coordinate system with other augmented reality devices. The augmented reality device generates a local coordinate system and merges the local coordinate system with a global coordinate system. The local coordinate system is generated using a SLAM system with a build-in camera in conjunction and in some embodiments with other sensors such as an inertial sensor and a depth sensor. The local coordinate system is merged with additional local coordinate systems to generate a global coordinate system relative to objects observed by the local coordinate system. This allows users of each device to interact within the global coordinate system and provide interactivity of augmented reality objects across multiple devices and local coordinate systems. The global coordinate system may be stored remotely on a server or may be generated locally at a user device. Methods are provided for devices to join an existing global coordinate system or to merge a local coordinate system into an existing global coordinate system. The merger of two coordinate systems is determined based on the features identified in the landscape of each coordinate system and the identical features within.

After joining a global coordinate system, each augmented reality device may use the global coordinate system to track its location relative to the global coordinate system, and may provide additional mapping details to the global map. Thus, each user device may share details regarding its local environment and update the environment for use by other user devices. A database of the environment features is used for tracking, mapping, meshing and surface understanding. The database may be stored on a server and shared between the augmented reality devices and updated by devices viewing the environment.

### Example Computing Environment

Figure (FIG.) 1. Illustrates one embodiment of an environment for a collaborative multi-user augmented reality experience. Users 1, 3, and 4 operate associated mobile devices 11, 13, and 14. The mobile device operated by the user device may take various forms, such as a hand-held computing device, a tablet, eyewear, or other and other has either a personal mobile device 11, tablet 13, or smart eyewear 14. The mobile devices each capture information about the joint environment 12. The mobile devices maintain mapping information of the environment and use features in the environment such as edges, light sources, and other aspects of the environment to determine objects in the environment and to determine the position of the mobile device within the environment 12. Each system may generate and render virtual content, such as an object, character, animation, or other information for placement on a display and rendered on a display screen for the user. A “mapping” refers to a virtual representation of the environment 12, including features identified in the environment. Since each mobile device observes a different portion of environment 12, each mobile device may generate a different local mapping. The local mappings may also be associated with a local coordinate system, indicating, for example, the position of objects, the rotation of the device, and the scale of objects in the mapping based on a coordinate system initialized by each mobile device.

In order to manage joint use of an AR system, the mobile devices 11, 13, and 14 translate the local mapping and coordinate system to a joint (“global”) mapping and coordinate system. The translation of mapping information into a global coordinate system allows the mobile devices to share information regarding locally information. The locally-perceived information can include objects in the environment 12, the location of each mobile device, and the location and interaction of any virtual content maintained by the mobile device or managed by the user of the mobile device. Using the joint coordinate systems, users 1, 3, and 4 simultaneously interact with each other both directly, through speech and eye contact and indirectly through virtual worlds interaction on the screens and displays of their devices.

Referring now to FIG. 7, it illustrates one embodiment of a mobile device 700 implementing a shared coordinate system. The mobile device 700 includes a variety of modules and components for determining information about the environment 12 and communicating with additional mobile devices. These modules and components include a camera 705, a feature mapping module 710, a pose (position+orientation) module 715, sensors 720, a map merging module 725, a display 730, a virtual content manager 735, a local mapping 740, a global mapping 745, and virtual assets 750. The camera 705 captures a video feed of the environment 12. The feature mapping module 710 analyzes the video feed of the environment 12 to identify real-world objects in the environment 12, such as light sources, edges, objects, and other aspects of the environment 12.

In one embodiment, the feature mapping module 710 generates a 3-D point cloud (map) of the real world and registers the location of the mobile device using simultaneous localization and mapping (SLAM). The SLAM approach identifies features in a video feed of the environment. This enables registration of features in an environment without prior information defining the features in an environment. The features determined by the feature mapping module 710 may be stored in a local mapping 740 or may be added to a global mapping 745. The local mapping 740 includes a database of points of interest identified in the environment 12. The global mapping 745 includes features from sources other than the mobile device 700, such as other mobile devices or from a server.

The pose module 715 determines the position and orientation (“pose”) of the mobile device 715 relative to the local mapping 740 and/or the global mapping 745. The pose of the mobile device may be determined by identifying the location of the features in the mapping in addition to the previous location of the mobile device. The determination of the pose of the device may be complemented by additional sensors 720 on the augmented reality device. The pose module 715 may also be used to determine the location of the device without a prior location of the mobile device within a mapping. For example, the mobile device may access a global map of an area for the environment 12, but the mobile device may not know the location of the mobile device 700 within that mapping. Methods for determining the position of the mobile device 700 are further described below.

The sensors 720 include various additional sensors that provide additional position tracking information. Such sensors 720 vary among embodiments, but generally include accelerometers, gyroscopes, magnetometers, and may further include, but is not limited to, a rangefinder (i.e., to determine the distance to an object), a global positioning satellite (GPS) receiver, a cellular towers support, when network is available, a range differentials support for collaborative navigation, an altitude sensor, a photo resistor and a clock. The sensors 720 may also be used to determine with increased accuracy the “true” coordinates of a local mapping.

The map merging module 725 determines a translation, rotation and scale correction of local mapping 740 to global mapping 745 and enables the combination of the local mapping data with the global mapping data. The map merging module 725 may be used to allow the mobile device 700 to initiate a global map or to join a pre-existing global map. The map merging module identifies axes along the coordinate systems of the merged maps for which sensors 720 may reduce the degrees of freedom for merging the maps. For example, the map merging module 725 may use a magnetometer to determine which direction in a coordinate system is north. By knowing the direction that is north, the possible ways to combine the maps is reduced and assists in enabling the identification of similar features and identified objects in the environment 12 that may serve as a point to merge the objects.

The display 730 provides an interface to the user and typically displays the video feed from the camera 705 along with virtual content overlaid on the video feed of environment 12. The virtual content placed on the display 730 is controlled by the virtual content manager 735, which controls and animates the virtual content for placement on the display 730. The virtual content manager controls the movement and animation of virtual contents stored as virtual assets 750. The virtual content manager 735 displays locally-managed virtual assets 750 and also receives virtual assets 750 from other mobile devices for placement on the display 730.

The mobile device 700 also includes a communications module enabling communications through a network or directly with other mobile devices 700 and a server (not shown). Such communications can be implemented through a variety of protocols, such as Wi-Fi, cellular transmissions, BLUETOOTH™, and other suitable technologies.

Additional details of an augmented reality system for determining features of a local environment and determining the position of a mobile device within the local environment is provided in U.S. application Ser. No. 13/774,762, filed Feb. 22, 2013, the contents of which is hereby incorporated in its entirety.

In general, the mapping and pose determination of the device is summarized as follows: The system determines an initial pose of the mobile device 700 relative to a coordinate system. The coordinate system may be a global coordinate system as described herein, or the coordinate system may be determined from a local coordinate system based on visual features of the environment 12 in combination with additional sensors 720 such as accelerometers, magnetometers, and a GPS receiver. These additional sensors may allow the device to determine a gravity orientation, North orientation, the scale of features, and to identify the location of the device relative to generated 3-D point cloud in the coordinate system. The feature mapping module 710 builds a map of 3-D points (mapping point cloud) representing the real world observed by the camera 705 while simultaneously the pose module 715 tracks the position and orientation of the mobile device 700 relative to the map. Virtual content is by the virtual content manager 735 for an AR experience when the device identifies its location relative to the coordinate system and the view of the device includes virtual content. As the user moves the mobile device and additional features are identified, the system continues to add to the map of 3-D points (or features) and thereby expand trackable area in the coordinate system.

Turning now to FIG. 2A-B, illustrated are map creation and handling according to various embodiments. FIG. 2A illustrates a single user embodiment showing map creation, handling and updating using communication with a server. In Single Device Initialization 21 mode, a first user creates an initial map of the environment, and starts a single-device experience while the mobile device 20 is tracked 22 from the created environment and simultaneously created map is further improved and extended 23. That is, as the device 20 is moved around the environment 12, additional features are identified and the map locally known by device 20 is updated with additional information from the environment. The map database is saved on device 20 as a local mapping 735. Upon creation of initial map it is sent to Server 27, where there is a Map Storage 25. Later on when a device revisits the same environment and uses the same map, it could be further extended by merging the maps 26. A device can request a global merged map or part of it from the server through the map download mechanism 28.

FIG. 2B illustrates a multiple-user embodiment showing illustrating map creation, handling and update using communication with the server. In this embodiment, the merging of maps is managed by the server. Accordingly, the server may introduce a processing delay in providing the map merger. As a result, initially each device uses a single device mode and moves to a collaborative mode (using the global map) after receiving merged map data. In this mode Server 27 holds a map produced and used by each user independently, until map merge from different users becomes possible. Once the maps can be merged, the user devices associated with the individual maps that were merged can be added to the merged map.

FIG. 3 is a method for illustrates map processing on a server with a simultaneous broadcast mechanism to participating devices. Each device performs local map update/map addition 31. Server 27 has a map storage mechanism 32, where the initial map from each device is stored separately on server 27 until the maps can be combined (“stitched”) by map stitch mechanism 33. The map stitch mechanism is further defined below with reference to map merging. After map stitching, some of the features in the maps may be represented twice in similar locations, so double feature instances are removed by double feature instances cleaning block 34 to filter duplicative features in the combined map. Finally the map is translated through the global coordinate system refinement block 35 to better align the coordinate system of the stitched map to a global (world) coordinate system. The global coordinate system may be a single global coordinate system e.g. identifying the actual placement and mapping of objects worldwide, or the global coordinate system may refer to a group of individual maps stitched together in a common coordinate system. The resulting map broadcast to devices 36, and a message indicating the broadcast is generated in one embodiment or the merged map is broadcast periodically to all participating devices.

FIG. 4A-B illustrate an embodiment for map processing among devices. FIG. 4A illustrates a method for using maps initialized from a map on a first device 40. Once the initial map created by the first device is available for sharing 41, other participating devices are able to download the initial map 42 created by device 1. After that all devices including device 1 operate independently on their local maps 43. In this embodiment each local map originates the initial local map of device 40.

FIG. 4B illustrates another embodiment wherein each device initially determines local features and a local coordinate system. This may be used, for example, because maps could not be merged yet, which may be because the devices observe the environment 12 from substantially different viewpoints. In this mode each device operates on its own map 44 and then broadcasts its local map 45 to all other participating devices and/or a server. Depending on a selected configuration, either each device or the server attempts to merge 46 two maps, such as a device's local map with the map received via a broadcast from another device. If the merge is successful, the corresponding devices distribute the merged map and switch to tracking and determining features based on the merged map, which may eventually become a global map 47

FIG. 4C illustrates the close-up of Broadcast Block 45, illustrating methods of broadcasting map data. The broadcast block can transmit initially only necessary data 451; transmit a reduced subset of data, 452 exclude from transmission data that can be recalculated 453, or the map data may be compressed 454 prior to broadcast. A combination of these methods may also be used, for example the key information may be transmitted after being compressed. When the device attempts to merge a map, the attempt to merge first attempts to reduce the degrees of freedom 461 for the separate maps. That is, information from other sensors is used to determine whether common information can be determined about the coordinate systems of the two maps. Next, the features in each map are attempted to be matched 462 by identifying features that are in common between the maps. Since the maps may be in different coordinates with different degrees of freedom, the matched features may be attempted by translating the features along any axis that maintains a degree of freedom, by rotating along any axis, or by scaling the distance between features. For example, the “north” of direction of two maps may be known, but the rotation of devices relative to one another may not be known, in which case the feature match may attempt to find a coordinates transformation that matches the features, but not change the “north direction” since that direction is known with respect to the two maps and coordinates. After the feature match, the maps and coordinate systems are translated, rotated and scaled by the determined translation, rotation and scale to determine the feature match, and the remaining features are used to verify the translation, rotation and scale are valid 463.

FIG. 5A illustrates an exchange of data after the devices have merged maps and identified the position of the device relative to the merged map. In this embodiment, the devices transfer data through a server 27. Each device 20 transmits its own virtual assets (calculated by the device itself). Device 20 also displays its own virtual assets and virtual assets of other devices received through broadcast. Server 27 stores all virtual assets from all devices that are involved in certain collaborative activity.

FIG. 5B illustrates a similar exchange of virtual assets without a server. In this embodiment each device 20 performs four main functions: Transmits its own virtual assets 502; Receives virtual assets from other devices 504; Combines the device's own virtual assets with virtual assets from other devices 503, and displays the combined virtual assets 501 within the field of view of the device. The sharing mechanism involves an Individual Device Virtual Datastream 50. That is, each individual device provides a datastream specifying the virtual assets of that device.

### Coordinate System and Map Merge

Two coordinates system merging methods are labeled “Join” and “Merge.” In the join method, the first device (master) creates its own local coordinates system that it shares on the cloud. A device in the vicinity (slaves) can then download the created map to register the device to this coordinates system. The devices identify the location of the device on the downloaded map. After registering, the device adds additional detail to the map as the device views additional portions of the environment and can extend the map using the feature recognition described above.

Upon receiving of the map by device, it tries to locate and orient itself with respect to downloaded map. The camera on the device extracts frames of the video and on each frame finds standard image features, (for example edges, corners or bright spots). Since each feature or point in a map is accompanied by corresponding feature descriptors, those descriptors from the downloaded map could be compared against the observed frame from the camera, and once enough matches are found the device determines the map as a match for the device. Next, a standard computer vision technique (ex. triangulation, bundle adjustment) are applied to find a position and an orientation of the device with respect to downloaded map. This mechanism in general requires that the location of the device in space should be close to one of the locations of the first device that constructed original map such that features and points in the map correspond to features and points in the frames of video in the second device. In one embodiment, the features can be determined that are rotation-invariant, meaning that the features appear the same regardless of the rotational orientation of the device.

In the merge method, multiple users create their own coordinates system and merge the individual coordinate systems into a global coordinates system. This merges can happen on a mobile device or on a server. When the merge is executed on the server, the server receives frequent updates from the mobile devices and attempts to merge maps when a map is updated with additional features. The server tries to merge local coordinates system and informs the user device when it is successful. In this way, each user device is aware of the status of the map accuracy, boundaries of the currently mapped area, and other details of the merging process.

To execute a map merge, the likelihood of identifying a coordinate translation orientation and scale that successfully merging the maps is improved if the number of degrees of freedom (i.e. the possible unknown dimensions in which the coordinates may differ) is reduced. In general, the maximum number of degrees of freedom between local transformations includes translation in x, y, and z axis, rotation about the same axes, and the scale of each map.

The number of degrees of freedom to be estimated is reduced in one embodiment using additional sensors on the device as described above. Specifically, reducing the degrees of freedom enables the coordinate system to determine a known orientation for a particular axis. For example, the AR system may identify that a particular direction is “north” (or “north” within a margin of error) using a magnetometer, which enables the AR system to determine that a particular direction in its local coordinate system is also “north” (within a margin of error). By reducing the degrees of freedom, the possible orientations of the local coordinate system with respect to the global coordinate system are reduced, increasing the likelihood that the features in the local coordinate system can be merged with the features in the global coordinate system.

Sensors that can reduce the degrees of freedom in the coordinate system include any available sensors 720, such as a global positioning system (GPS) receiver, an Inertial Navigation System (i.e., accelerometers, gyroscopes, magnetometers), or by range-finder. Using gravity information from an accelerometer or a group of accelerometers would reduce the number of degrees of freedom by one, while using magnetometers to estimate direction of magnetic north would reduce the number of degrees of freedom by one. Using magnetometers and accelerometers together would reduce the number of degrees of freedom by three. Additionally integrated INS data or rangefinder can be using to restrict scale and as a result also reduce number of degrees of freedom by one.

For example, accelerometers may be used to estimate orientation of the mobile device 700 relative to a gravity axis. Many mobile devices are equipped with three orthogonal accelerometers to measure acceleration in any direction. In any device orientation (when device is static) ax²+ay²+az²=g², where g=9.8 m/sec², and ax, ay and az represent the corresponding measured accelerations along body-frame axes x, y and z respectively. This force on the device allows a calculation of a direction of the effect of gravity, and therefore the gravity axis, and thus to calculate an orientation of the device with respect to such an axis with relatively low error. When two coordinates are gravity aligned it restricts one degree of freedom for coordinates of the devices.

As another example, if a magnetometer is available to provide a magnetic compass, in addition to accelerometers, then both directions to North and East are available as well and can reduce the number of degrees of freedom further. Additional degrees of freedom may be reduced by using locational data, such as a GPS or Wi-Fi signal strength to determine the latitudinal and longitudinal location of the device, with an error based on the accuracy of the GPS receiver and signals. For each degree of freedom restricted by the additional sensors, the likelihood of accurately identifying the correct coordinates system transformation and locations to merge maps is increased.

Once multiple users share common coordinates system, they can share application specific information. Possible shared application information includes, for example, the position of the mobile device, the location of virtual content within the global coordinate system, a waypoint in the coordinate system, a path as a set of waypoints, device pose in 6-DOF or the position of assets.

Thus, these method enable sharing of maps across augmented reality systems in the presence or absence of a previously build map, whether a previously built map is stored on a server or locally on a device, and enables a master-slave map construction or joint map construction. In one mode of operation, the same map is shared between players in full during the AR experience, while in another mode of operation, only core part of the map is joint, while additions to the map are managed locally by each device. Map exchange may be is done directly through bluetooth (or similar) connection between devices or a map may be shared through the cloud-based solution involving the server, Wi-Fi, TCP/IP or other similar protocols.

Typical Map Exchange process requires broadcasting and receiving a substantial amount of data on the order of several Megabytes. With current WiFi transmission rates it may take multiple seconds to transfer such amount of information. Since delays in transmission strongly impact the user experience, the transferred data is reduced through map sparsification. The size requirement for a map used for tracking is substantial as it needs to incorporate frames and point cloud information of the map of the environment. To reduce the amount of transmission, the information is transmitted according to the following method: First, the device only transfers information that is necessary to support initial operations such as tracking Later additional information is transferred to improve tracking quality, increase tracking volume, and other wise improve tracking in of the device in the map. Second, some data is cheaper to recalculate locally on device, rather then transfer. For example, one processing implementation calculates bundle adjustment multiple times for multiple feature resolutions in order to refine 3-D feature locations. This is a computationally expensive operation. Instead, here we calculate bundle adjustment a limited number of times for one feature level resolution, transmit this only roughly calculated feature location together with the fact that it was only calculated limited number of time and then complete an operation on receive side. Third, only a subset of images are transferred. The selected images are the images that provide a large coverage of the scene with a limited footprint that is still usable in tracking scenario. Additional standard technique such as file compression, or image compression can be used to further reduce the size of the transferred data. All the combination of compression techniques allows for a very quick map transfer, and consequently users could quickly join an experience.

In one embodiment of initiating a joint coordinate system and managing interactions between the mobile devices, a first device determines an initial 3-D location and details reducing degrees of freedom, such as gravity direction, North direction, scale, and previously known optical features. Next, the first device builds a map of 3D points (mapping point cloud), while simultaneously tracking the location of the device relative to the map. When the map on the first device becomes sufficiently large for good user experience (a “Good Map”) virtual content is added and rendered for the user on the first device.

The first device saves the map to a file, compresses it using sparsification methods and broadcasts it to a central map server as described above (if such server is available in specific architecture). Additional devices join the application without going through detailed initialization and download the compressed map from the central map server or directly from the first device. The additional devices initialize (and recover) tracking from a position that's already known and connected to a frame captured by the first device. Since the additional devices have obtained tracking from a position known to the first device, the additional devices and the first device now track in the same coordinate system.

Further map extensions and updates can be handled by several methods, alone or in combination. First, the first device saves a new Good Map periodically as described above when the map generated by tracking new features becomes substantially different from the old Good Map by either amount of features, their accuracy or both. The additional devices periodically inquire from the server or the first device if there is a change in Good Map, and if so, the additional devices retrieve the updated Good Map.

In another map extension method, all of the devices (including the first device) use the initial Good Map provided by the first device, while map extensions are handled locally on each device. One benefit of this method is low usage of network bandwidth. It is a preferable method of handling maps when a server is not available and the initial Good Map was transferred via a lower bandwidth connection from the first device. The maps from each device must be merged subsequently to maintain joint tracking outside of the initial Good Map provided by the first device.

In another map extension method, all the devices (including the first device) save updated maps periodically and broadcast the updated maps to the server. Often it is computationally cheaper to broadcast a submap of entire map. This submap is typically the one to where the corresponding device is “looking at.” A map merge from the different devices is handled on the server, where an accurate Good Map including several devices' mapping (Super Map) is created. Each Device downloads Super Map periodically from the server to substitute locally stored Good Map.

It is noted that in one example embodiment, when the Super Map gets large relative to transmission or memory capabilities, it may exceeds the available memory capacity of particular local device. In that case the server handles the Super Map as a set of location-based sub-maps. Consecutively, each Device operates from the corresponding sub-map from the Super Map and when its location is changed substantially the local submap of the Super Map is replaced by matching one from the server.

During the application use (e.g., game play) each device broadcasts its device and application information to the server (if a server is available). Such device and application information contains device location information (i.e., position and rotation of the device) as well as all relevant virtual assets information. For example, when multiple players control their own virtual RC cars, several cars may be physically visible by some of the devices. In this case these several RC cars are displayed on the corresponding device screen. Devices receive the virtual asset information directly from other devices or by polling the central pose server. In one embodiment each device pair, communicates directly with one another, for example by a proprietary BLUETOOTH™ communication channel to exchange device and application information.

This architecture is unique in one embodiment in that the devices share the same global (or local location based) coordinate system. Players do not necessary need to see each other, for example some of the players can be in different room(s) from other players, or some of the players could be indoors, while others could be outdoors.

Another benefit is that device position and application content updates are handled through normal network communication, and do not require any special communication between the mobile devices. Thus, low-level TCP/IP communication may be used, which eliminates the need and dependency on proprietary infrastructure, such as special sender and receiver hardware.

Yet another benefit, is that any user visiting already mapped location does not have to go through an initialization process to identify aspects of a map and determine a coordinate system, such that a network effect is achieved, i.e. the number of areas with an available initial position determination grows with growing number of users, and the application(s) runs eventually creating a collaborative 3D environment of the world. It is also must be noted that different users could be using totally different application, while contributing to the same map expansion, since the Super Map is application independent.

### Computing Machine Architecture

FIG. 6 is a block diagram illustrating components of an example machine able to read instructions from a machine-readable medium and execute them in a processor (or controller). Specifically, FIG. 6 shows a diagrammatic representation of a machine in the example form of a computer system 600 within which instructions 624 (e.g., software) for causing the machine to perform any one or more of the methodologies discussed herein may be executed. The computer system 600 provides an example architecture for executing the processes described throughout the specification. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes a processor 602 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 604, and a static memory 606, which are configured to communicate with each other via a bus 608. The computer system 600 may further include graphics display unit 610 (e.g., a plasma display panel (PDP), a liquid crystal display (LCD), a projector, or a cathode ray tube (CRT)). The computer system 600 may also include alphanumeric input device 612 (e.g., a keyboard), a cursor control device 614 (e.g., a mouse, a trackball, a joystick, a motion sensor, or other pointing instrument), a storage unit 616, a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 (e.g., software) may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., instructions 624) for execution by the machine and that cause the machine to perform any one or more of the methodologies disclosed herein. The term “machine-readable medium” includes, but not be limited to, data repositories in the form of solid-state memories, optical media, and magnetic media.

As described, these systems and methods considerably improve user experience relative to prior art systems. First the global coordinate system does not require any external hardware to the mobile devices themselves. Each user only needs a mobile device such as smart phone, tablet, smart eyewear, or any similar device as described above for processing a shared AR experience. Secondly, since the tracking and mapping systems do not require designated landmarks, experience sharing may be to be virtually anywhere features can be mapped and tracked, including a home, coffee table in cafe, bench in a park, or hiking trail in a forest. Thirdly, each user's content is displayed on their personal device, so the user can alternate looking into their screens and also interact face to face without any loss in the shared experience. Finally, users can touch, move, remove from or add to objects in shared environment that is propagated in substantially real time to the other mobile devices and as a result simultaneously interact with each other in both real world and virtual world.

This architecture does not limit the number of users operated in the same environment. Furthermore, since core value of the invention is an ability to initiate, build, receive and broadcast 3D map of the environment between users, while all these operations occur in joint 3-D coordinate system, the larger amount of users naturally contributes to better joint user experience, such as an ability to create larger shared environment and/or more accurate environment.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 602, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating joint coordinate and mapping systems through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for a shared augmented reality experience, comprising:
accessing a first local feature map of an environment in which a mobile device is located, the first local feature map associated with a first local feature map coordinate system;
receiving, a second local feature map of the environment associated with a second mobile device, the second local feature map associated with a second local feature map coordinate system;
merging the first local feature map and the second local feature map to generate a joint feature map of the environment;
determining the position of the mobile device relative to the joint feature map.

2. The computer-implemented method of claim 1, wherein merging the local feature map comprises determining reduced degrees of freedom of the first local feature map and the second local feature map.

3. The computer-implemented method of claim 2, wherein the reduced degrees of freedom are based on sensor data associated with the mobile device and the second mobile device.

4. The computer-implemented method of claim 3, wherein the sensor data comprises at least one of: accelerometer data, gyroscope data, magnetometer data, rangefinder data, global positioning satellite receiver data, cellular tower data, range differential data, altitude data, photo resister data, or a clock.

5. The computer-implemented method of claim 1, wherein merging the local feature map comprises eliminating duplicative features of the first local feature map and second local feature map from the joint feature map.

6. The computer-implemented method of claim 1, wherein merging the first local feature map and the second local feature map comprises determining a coordinate system translation between the first local feature map and the second local feature map.

7. A computer-implemented method of managing communication of a joint feature map in an augmented reality system, comprising:
accessing a feature map associated with a joint feature map maintained with respect to a global coordinate system;
receiving a video feed of an environment;
determining environment features from frames of the video feed of the camera;
determining a pose of a mobile device relative to the joint feature map;
identifying at least one feature from the environment features not included in the feature map associated with the joint feature map;
adding the at least one feature not included in the feature map to the feature map;
broadcasting the added at least one feature to a second mobile device.

8. The computer-implemented method of claim 7, wherein prior to broadcasting the at least one feature, the at least one feature is reduced using data sparcification.

9. The computer-implemented method of claim 7, wherein prior to broadcasting the at least one feature, the at least one feature is reduced using data compression.

10. The computer-implemented method of claim 7, wherein the joint feature map is stored on a server, and further comprising receiving, by the server, the added at least one feature and merging the at least one feature to the joint feature map.

11. A computer-implemented method for sharing a joint feature map, comprising
generating, on a first mobile device, a feature map of an environment based on features identified from a first video feed;
providing, by the first mobile device, the feature map of the environment to a second mobile device;
receiving, by the second mobile device, the feature map of the environment;
determining, by the second mobile device, second features of the environment identified by a video feed from a camera on the second mobile device;
using, by the second mobile device, the feature map received from the first device as a local feature map; and
identifying a position of the second mobile device relative to the local feature map by comparing the features in the local feature map to the second features.

12. The computer-implemented method of claim 11, further comprising:
generating, on the first mobile device, augmented reality content associated with a location in the feature map;
transmitting, by the first mobile device, the augmented reality content to the second mobile device;
generating a display on the second mobile device including at least a portion of the augmented reality content responsive to the video feed including a portion of the environment including the location;
providing the display to a user of the second user device.
